(19) United States
(12) Patent Application Publication
(10) Pub. No.: US 2012/0205510 A1
(43) Pub. Date: Aug. 16, 2012

(54) SIMULTANEOUSLY UNLOCKING TELESCOPIC STAND DEVICE

(76) Inventor: Stéphane Dominique Philippe Fortier, Seugy (FR)

(21) Appl. No.: 13/389,918

(22) PCT Filed: Aug. 17, 2010
(86) PCT No.: PCT/FR10/00575

§ 371 Date: Apr. 13, 2012

(30) Foreign Application Priority Data
Aug. 25, 2009 (FR) 0904041

(51) Int. Cl. F16M 11/26

(52) U.S. Cl. 248/423

(57) ABSTRACT

The invention relates to brake systems for telescopic stands, the lugs (11) of which for supporting same in the unfolded position are simultaneously disengaged by pressing the control trigger (3) to achieve unfolding and folding without any untimely locking of said telescopic stands. In the unfolded position of the telescopic stand, the lugs (11) are inserted into the holes (8) of sliding segments (7) by tensioning and movement of a flexible link (15). Pressing the trigger (3) moves the flexible link (15) to the bottom and simultaneously frees the springs (13) which compress the lugs (11) inside inner brackets (9), enabling the sliding and folding of said sliding segments (7). The invention can be specifically used for telescopic stands for video or still cameras, telescopic luggage handles, and telescopic storage devices.

### TECHNICAL FIELD

The invention relates to telescopic supports whose blocking-bolts lock systems are simultaneously retracted by a pressure from the user on the control trigger, in order to obtain an easy deployment and folding of the aforementioned telescopic supports.

### PRIOR ART

Tripods supporting photographic apparatus and cameras as well as telescopic baggage handles comprise telescopic supports that exhibit inconvenient lockups during their deployment and folding.

In fact, the telescopic handles and in particular those of the “pilot-case” type baggages which generally comprise two telescopic supports comprising multiple sliding segments fitting into each other and connected by a handle equipped with a control trigger of the lock system, require, in order not to block their folding process, coordinating multiple manipulations simultaneously: the user must press on the trigger and lower the telescoping supports with constant speed while maintaining the handle in a common vertical axis despite the inclination of the supports. What constrains their use.

This problem is caused by the lock system that is part of the telescopic supports and enables holding of them in extended position: in fact, in this system, the sliding segments comprise orifices wherein bolts automatically engage under the force of springs when the aforementioned orifices are aligned with the aforementioned bolts. For refolding, the disengagement of the upper bolt is performed directly by a press on the control trigger but the disengagement of the lower bolts is achieved by alternate interlocking of the sliding segments into each other and the press of their lower end on the bolt of their adjacent segment. A clearance being necessary to enable easy sliding between two sliding segments, these clearances causes a consequent horizontal displacement between the lowermost segment and the most elevated segment. The aforementioned clearances of the two supports of the telescopic handle thus create a lateral movement of the assembly and cause, during the folding, the inclination of the handle, which causes a shift, lowering of a telescopic support relative to the other and a shift of the disengagement of their bolts, thereby causing blocks.

Similarly, during the process of deployment of the telescopic handle, the bolts compressed by the springs engage in the orifices of each sliding segment as they pass and block the elevation of the handle if the press of the trigger is not effective or if the elevation of the sliding segments is not symmetrical and simultaneous.

It would therefore be advantageous to resolve one or multiple of the problems identified with a device that enables the simultaneous disengagement of all blocking bolts by a single pressure on the control trigger for greater ease of use of telescopic supports.

### DISCLOSURE OF THE INVENTION

In order to solve one or more of the disavantages cited above, a telescopic support device with simultaneous unlocking comprises:
a spring trigger, controlling the tensioning and the release of a flexible link connected by its upper end to the aforementioned trigger and by its lower end to the base of the lowermost sliding segment, and
multiple sliding segments fitting into each other, each sliding segment comprising a sliding segment comprising an internal e, each internal support comprising a recess through which travels a bolt equipped with a spring whose force compresses the aforementioned bolt into position into the interior of the internal support and the aforementioned internal supports comprising an orifice wherein the flexible link travels, along each bolt,

such as the aforementioned device is movable between three positions:
an extended position, obtained by the deployment of segments in maximum position, in which the bolts are engaged in the orifices of the sliding segments by the tensioning and the displacement of the flexible link, such that the aforementioned segments are blocked in their sliding,
an intermediate position, obtained, in the maximum deployment position of the sliding segments, by a press the trigger that displaces and slackens the flexible link, such that each spring compresses each bolt to the interior of each internal support, enabling the interfitting of the aforementioned segments on top of each other.
a folded position, obtained by folding of the sliding segments, in which the flexible link is slackened and each spring compresses each bolt to the interior of each internal support.

Particular implemenation mode features are:
Each internal support comprises a recess wherein a stop travels, such that, each stop being connected to the flexible link, in the extended position, each stop is displaced in each recess by the tensioning of the flexible link, driving the displacement of each bolt into outer position in the orifices of sliding segments.
Each orifice, wherein the flexible link travels, is positioned such that the tensioning of the flexible link displaces each stop in its recess driving each bolt into outer position in the orifices of the segments.
The internal recess of the support, wherein the stop travels, is inclined such that, each stop being attached to the flexible link, the tensioning and the upward displacement of the flexible link drives each stop in a stroke both vertical and horizontal, displacing each bolt into outer position in the orifices of the corresponding segments.
The flexible link is connected, at its lower end, to a spring less powerful than the spring of the trigger, such that in maximum extended position of the telescopic support, a press on the aforementioned trigger enables the aforementioned spring to drive the downward displacement of the flexible link as well as a partial relaxation of its tension.
The inclined recess of the internal support comprises a vertical portion positioned such that the stop at end of stroke engages between the aforementioned vertical wall and the bolt, enabling the blockage of the aforementioned bolt in outer position and releasing the flexible link from the force exerted by the spring of the bolt.
Each recess, wherein the stop travels, is vertical and the surface of each bolt in contact with the stop comprises an inclination such that, each stop being attached to the flexible link, the tensioning of the flexible link and the elevation of each stop causes the displacement of each bolt into outer position.
The surface of each bolt in contact with the stop comprises a vertical portion in its upper part such that, upon the tensioning of the flexible link, each stop at end of stroke engages between the vertical portion of the aforementioned bolt and the vertical wall of the aforementioned recess and blocks the aforementioned bolt in outer position, releasing the flexible link from the force of the spring.
Each stop has a rotary cam shape, such that rotation of each stop, generated by the displacement and the tensioning of the flexible link, drives the displacement of each bolt into outer position.
The surface of the rotary cam shaped stop, in contact with the bolt, comprises a flat portion at its end, such that when the stop is positioned at the end of stroke and the bolt in outer position, the longitudinal axis of the stop is aligned with the longitudinal axis of the bolt and the force of the spring on the aforementioned bolt blocks the aforementioned stop in stabilized position releasing the flexible link from the force of the spring.
The longitudinal axis of the rotary cam shaped stop, positioned at the end of rotation, goes past the longitudinal axis of the bolt in outer position, such that the force of the spring on the aforementioned bolt blocks the aforementioned stop in stabilized position against the wall of the recess containing the stop, releasing the flexible link from the force of the spring.
A handle interconnects multiple telescopic supports.
The trigger is positioned on the handle.
The flexible link is connected to the trigger by means of pulleys.

### BRIEF SUMMARY OF THE FIGURES

The invention will be better understood upon reading the description which follows, given only by way of example. For FIGS. 1 to 9 and 17 to 30, only one telescopic support is shown, and only a portion of the handle is shown.

FIG. 1 is a sectional view of a device according to a first implementation mode of the invention;

FIG. 2 is a sectional view of the device of FIG. 1 in intermediate position;

FIG. 3 is a sectional view of the device of FIG. 1 in folded position;

FIG. 4 is a sectional view of the device according to a variant of the device of FIG. 1;

FIG. 5 is a sectional view of the device of FIG. 4 in intermediate position;

FIG. 6 is a sectional view of the device of FIG. 4 in folded position;

FIG. 7 is a sectional view of the device of a variant of the device the device of FIG. 4 in extended position;

FIG. 8 is a sectional view of the device of FIG. 7 in intermediate position;

FIG. 9 is a sectional view of the device of FIG. 7 in folded position;

FIG. 10 is a sectional view of the device of a variant of the device of FIG. 7 in extended position;

FIG. 11 is a sectional view of the device of FIG. 10 in intermediate position;

FIG. 12 is a sectional view of the device of FIG. 10 in folded position;

FIG. 13 is a sectional view along the axis AA of the zone of the internal support of the device of FIG. 10;

FIG. 14 is a top view in section along the axis BB of the internal support of the device of FIG. 10;

FIG. 15 is a sectional view along the axis CC of the zone of the internal support of the device of FIG. 12;

FIG. 16 is a top view and in section along the axis DD of the internal support of the device of FIG. 12;

FIG. 17 is a sectional view of the device according to a second implementation mode of the invention;

FIG. 18 is a sectional view of the device of FIG. 17 in intermediate position;

FIG. 19 is a sectional view of the device of FIG. 17 in folded position;

FIG. 20 is a sectional view of the zone of the internal support of the device of FIG. 17;

FIG. 21 is a top view and in section along the axis EE of the zone of the internal support of the device of FIG. 20;

FIG. 22 is a sectional view of the device according to a third implementation mode of the invention.

FIG. 23 is a sectional view of the device of FIG. 22 in intermediate position;

FIG. 24 is a sectional view of the zone of the internal support of the device of FIG. 22 in folded position;

FIG. 25 is a sectional view of the internal support zone according to a variant of the device of FIG. 22;

FIG. 26 is a sectional view of the internal support zone according to a second variant of the device of FIG. 22;

FIG. 27 is a sectional view of the device according to a fourth implementation mode of the invention.

FIG. 28 is a sectional view of the device of FIG. 29 in intermediate position;

FIG. 29 is a sectional view of the device of FIG. 29 in folded position;

FIG. 30 is a sectional view of a support of the device according to a fifth implementation mode of the invention.

FIG. 31 is an isometric view of the device of FIG. 32;

FIG. 32 is a top view of the device of FIG. 31;

FIG. 33 is an isometric view of the internal support and of the flexible connection of the device of FIG. 9;

FIG. 34 is a top view of the internal support of FIG. 15;

FIG. 35 is a front view of the internal support of FIG. 15.

### DETAILED DESCRIPTION OF IMPLEMENTATION MODES

With reference to FIGS. 1, 2 and 3, a telescopic supporting device with simultaneous unlocking comprises a handle 1 on which is positioned a control trigger 3 equipped with a spring 5. The handle 1 connects two telescopic supports comprising three sliding segments 7. For simplification, a single telescopic support is shown. The three sliding segments 7 comprise orifices 8 and the two upper sliding segments 7 each comprise an internal support 9 which comprises a recess 10, wherein a bolt 11 travels, on which a spring 13 exerts a pressure holding the aforementioned bolt in the interior of each internal support 9. A flexible link 15, such as for example a cord, is attached to the trigger and to the base of the lowermost segment 7. The internal support 9 comprising a orifice 19 through which travels the flexible link 15, along each bolt 11. The mode of operation of the device is the following.

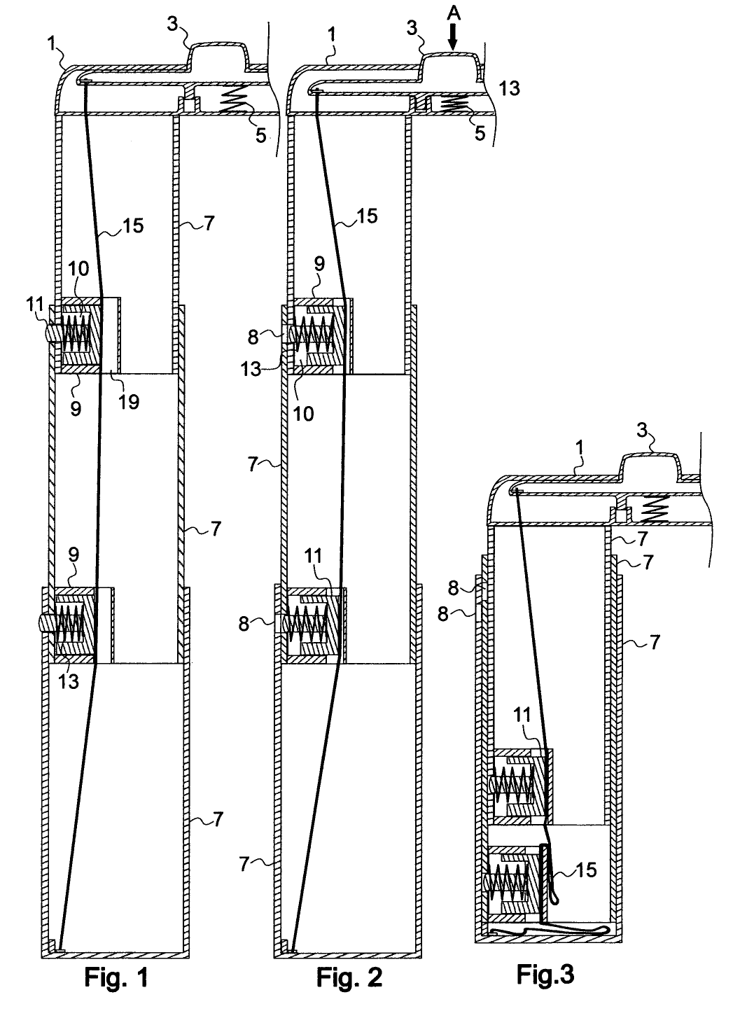

FIG. 2, to fold the device, the user presses (arrow A) on the trigger 3, the flexible link 15 is then displaced downwards, its tension is partially released and all the bolts 11 are compressed in the interior of the internal supports 9 by the force of the springs 13. The segments 7 are then free to slide and fit into each other under the force of the user, without risk of blockage.

FIG. 3 shows the device in its folded position, wherein the springs 13 compress the bolts 11 to the interior of the internal supports 9. The flexible link 15 is folded into the sliding segments 7. To extend the device, FIG. 1, the user lifts the handle 1, the segments slide 7 into the maximum deployed position, aligning their orifices 8 with the corresponding bolts 11. The flexible link 15 is elevated and tensioned by the positioning of the segments 7 by the spring 5 by whose power is greater than that of the set of springs 13. The flexible link, by its tensioning, displaces the bolts 11 into outer position in the orifices 8 of the segments 7 by compressing the springs 13. The play between the diameters of the orifices 8 and bolts 11 being less than the stroke of the aforementioned bolts, when the user releases the handle 1, the bolts 11 block the segments 7 before being displaceable under the force of the springs 13, which enables maintenance of the tension in the flexible link 15 and blocking the force of springs 13. The entire assembly is thus stabilized and the telescopic support is held in the extended position.

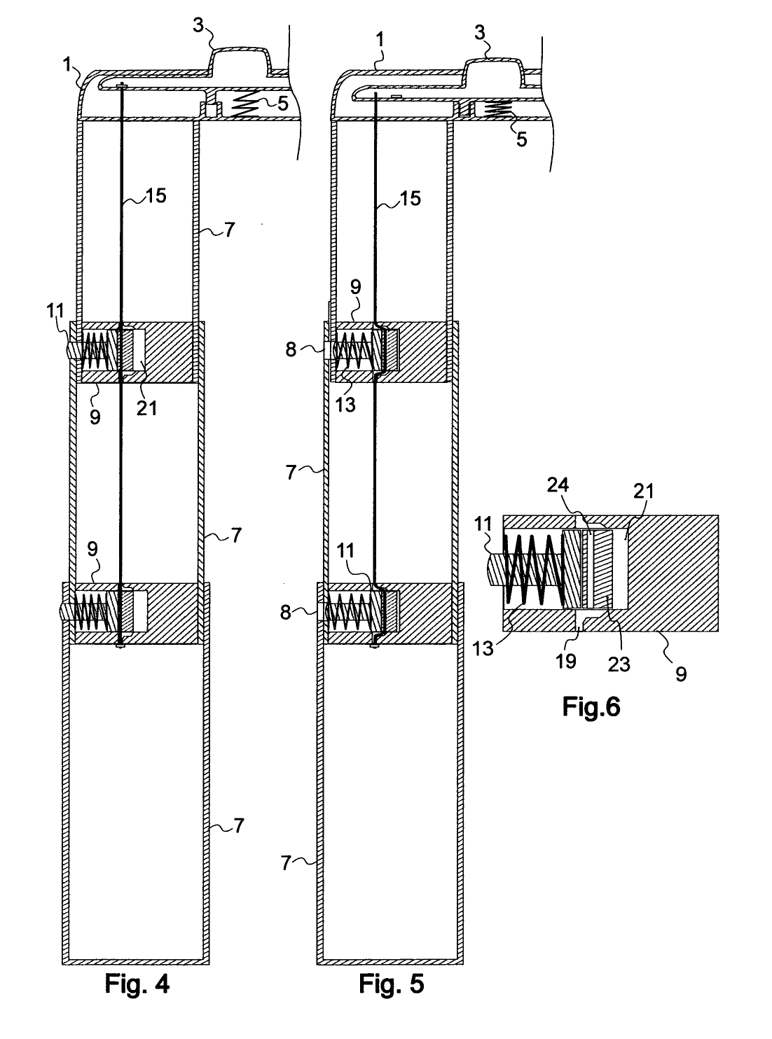

In a variant, FIGS. 4, 5 and 6, the flexible link 15 is attached on the lowermost internal support 9 and the internal supports 9 have larger dimensions, occupying the entire width of the segments 7. The internal supports 9 have a recess 21, wherein the stops 23 moves, each including an orifice 24 wherein the flexible link 15 travels. The positioning of the orifices 19 on the attachment rings 9 generating a point of support for the flexible link 15, its tensioning displaces the stops 23 guided in the recesses 21. The stops 23 being in contact with the bolts 11 their displacement compresses the springs 13 and drives the lateral displacement into outer position of the aforementioned bolts 11 in the orifices 8 of the segments 7.

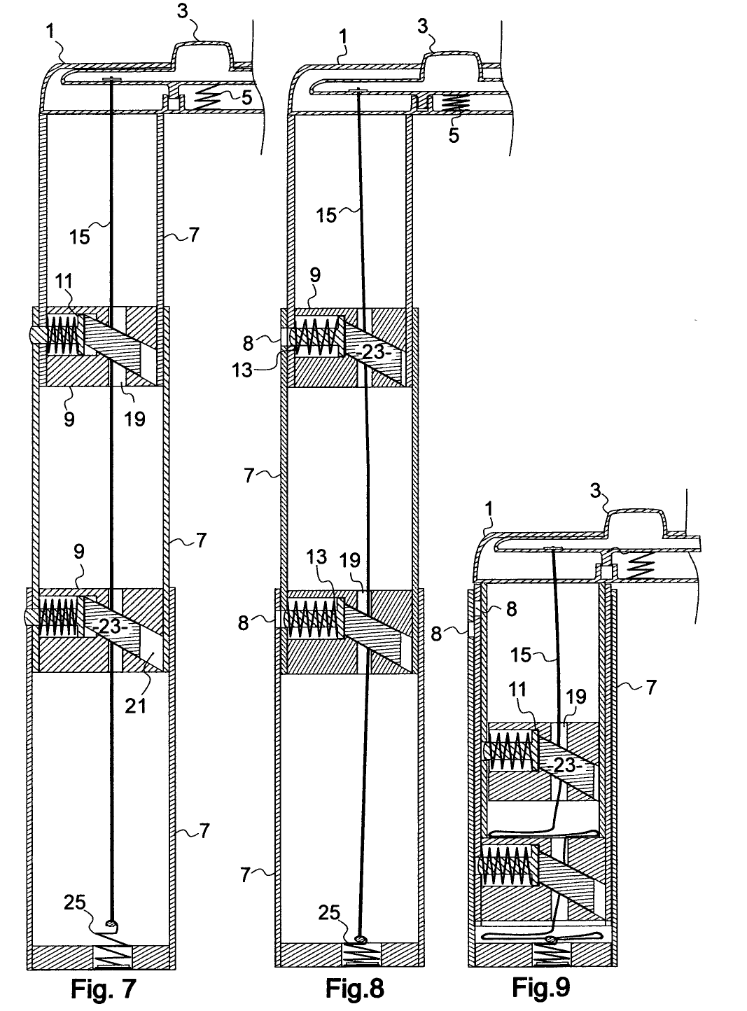

In a variant of FIG. 4, FIGS. 7, 8 and 9, the recesses 21, wherein the stops 23 travel, are inclined. The stops 23 are attached at a predetermined height on the flexible link 15 such that, elevated by the tensioning and elevation of the flexible link 15, they are horizontally offset by the inclined surface of the recesses 21 and displace the bolts 11 laterally into outer position by compressing the springs 13. The flexible link 15 is attached, at the base of the telescopic support, by a spring 25 which is less powerful than the spring 5 but more powerful than the set of springs 13.

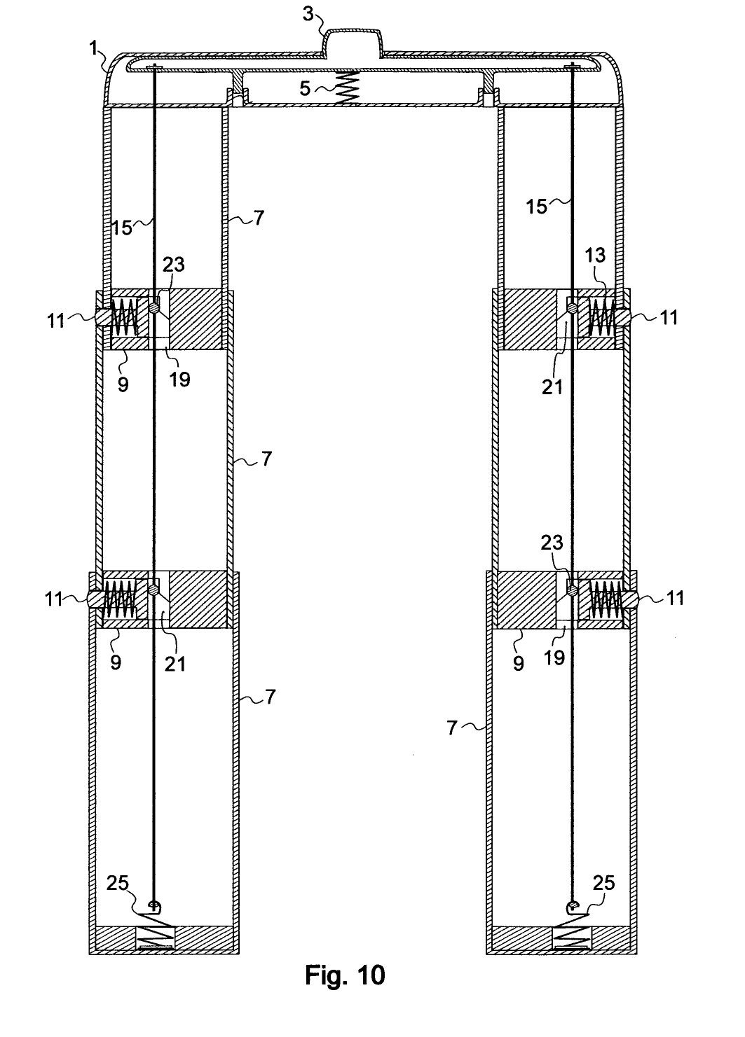

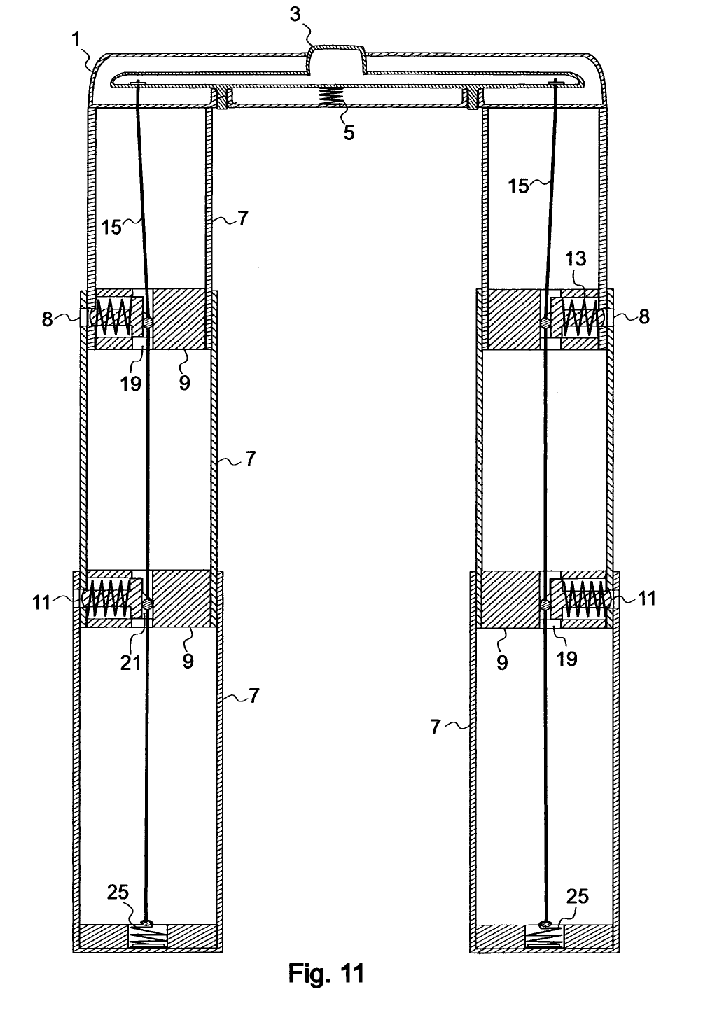

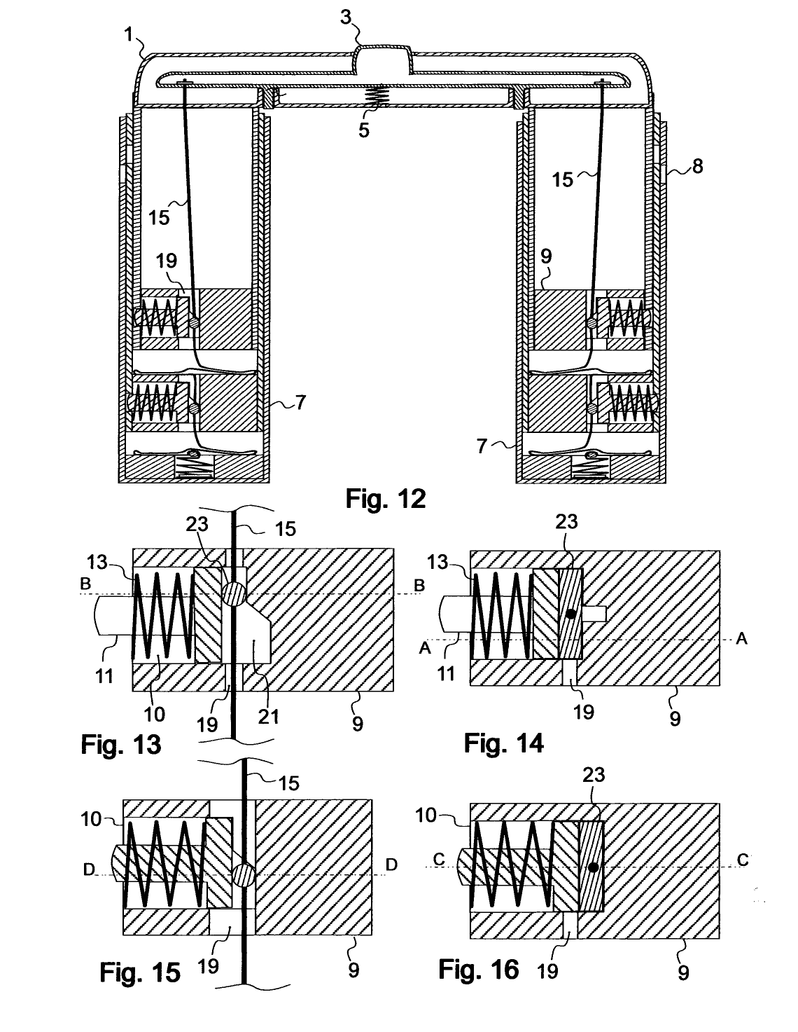

In a variant of FIG. 7, FIGS. 10, 11 and 12, the two telescopic supports constituting the telescopic handle are shown. FIG. 10, each recess 21 includes a vertical wall positioned in a predetermined manner such that when the flexible link 15, placed under tension and displaced upwards, pull the stops 23, at the stroke end, they are inserted between the aforementioned vertical wall and bolts 11 displaced in external position. The aforementioned stop 23 is then blocked between the vertical wall and the bolt 11 by the force of the spring 13, and held in a stabilized position, which enables releasing of the flexible link 15 from the force of each spring 13, and stabilizes the entire system in the extended position of telescopic support. In FIG. 11, when the user presses on the trigger 3, the flexible link 15, released from the pressure of the spring 5, is lowered by the spring 25, and partially slackened due to the lesser power of the aforementioned spring 25, the stops 23 are pulled downwardly, dislodged from their stable position and slide laterally on the inclined walls of the recesses 21 under the force of the springs 13 by means of bolts 11 which comes into inner position in the internal supports 9, enabling the user to lower the sliding segments 7. In FIG. 12, the device is shown in the folded position, the springs 13 compress the bolts 11 in the interior of the internal supports 9 and the flexible link 15 is folded in the sliding segments 7. The upper bolt 11 holding the stop 23 in the lowered position, which holding under tension in the portion of the flexible link 15 connecting the trigger 3 to the upper stop 23, and holding the aforementioned trigger in a low position and its spring 5 compressed. In FIGS. 13 and 14, the internal support 9 comprises an inclined recess 21 comprising a sloping vertical wall positioned in a predetermined manner at the end of stroke of stop 23 in order to block it between the aforementioned vertical wall and the bolt 11 when the flexible link 15 is displaced upward and tensioned. In FIGS. 15 and 16, the stop 23 is in low position, the bolt 11 is compressed by the spring 13 into inner position.

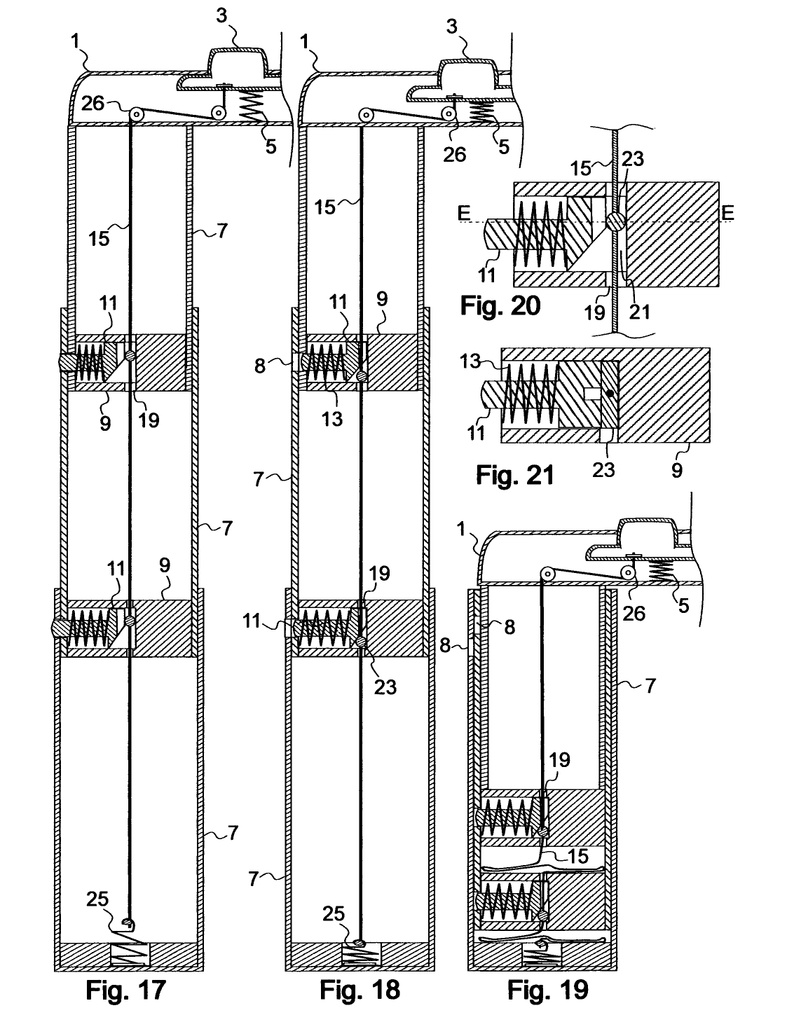

The second implementation mode, FIGS. 17, 18 and 19, comprises the same elements as the device of FIG. 4, it differs in that each stop 23 travels in a recess 21 whose walls are vertical, each stop 23 is attached to the flexible link 15 and the surface of the bolts 11 in contact with the stops comprises an inclined lower portion and a vertical upper portion. The flexible link is connected to the trigger by means of pulleys 26 attached on their axes of rotation and in the interior of the handle 1. The mode of operation is the following: The stops 23, elevated by the tensioning and the elevation of the flexible link 15, exert a pressure on the inclined surface of the bolts 11 which laterally displace into outer position by compressing the springs 13. At end of stroke, these stops 23 engage between the vertical wall of the bolts 11, and the vertical wall of the recess 21 in a stabilized position, enabling releasing of the flexible link 15 from the force of the springs 13, FIG. 17. When the user presses on the trigger, FIG. 18, the flexible link is 15 lowered, each stop is pulled down and the links 11 slide laterally under the force of the springs 13 into an inner position of the internal supports 9. In FIGS. 20 and 21, the stop 23 is at end of stroke, inserted between the vertical wall of the recess 21 in the vertical surface of the bolt 11, holding it in outer position.

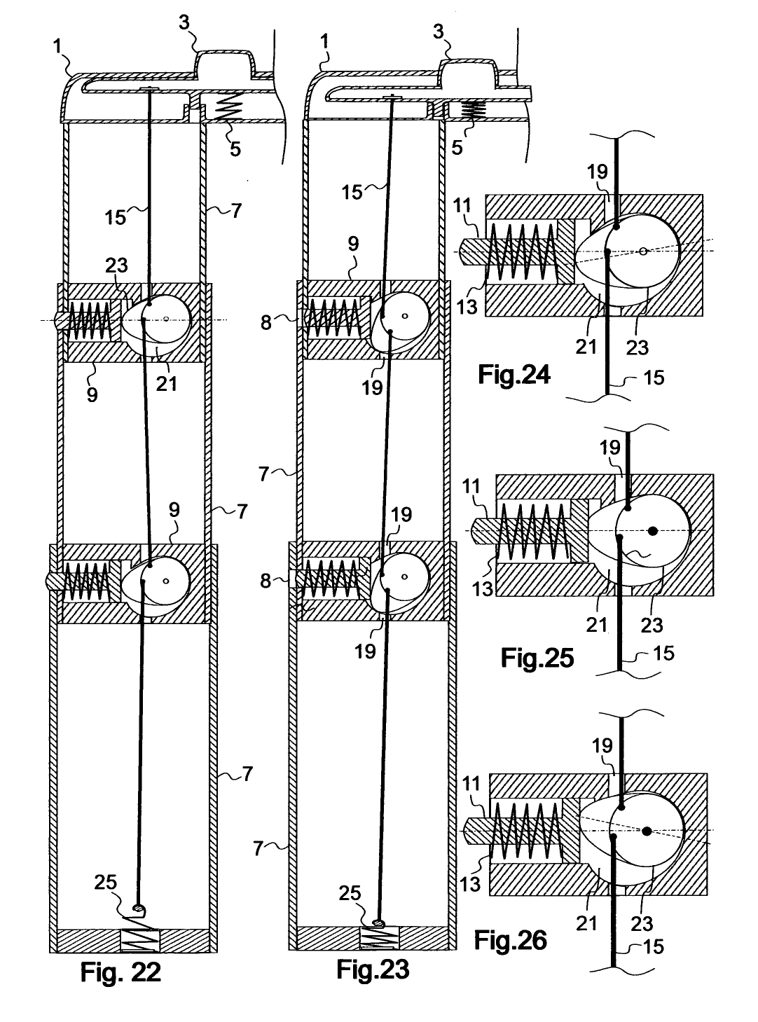

The third implementation mode, FIGS. 22, 23 and 24, comprises the same elements as the device of FIG. 4, it differs in that the flexible link 15 is attached on stops 23 in the shape of rotary cams which are attached to their axis of rotation, in the interior of a recess 21 made in the internal support 9. The mode of operation is as follows: FIG. 22, the tensioning and displacement of the flexible link 15 upward, drives the rotation of the stops 23 which laterally displace the bolts 11 into outer position. FIG. 23, when the trigger is compressed, the spring 25 pulls the flexible link down and the springs 13 compress the bolts 11 into the interior of the internal supports 9 and the stops 23 carry out a rotation in the opposite direction, pushed by the bolts 11. In FIG. 24, the bolt 11 is in outer position, the longitudinal axis of the stop 23 rests positioned under the longitudinal axis of the bolt 11 and the aforementioned stop and the flexible link undergo the force of the spring 13. FIG. 25 shows a variant of the device of FIG. 22 in which the cam shaped stop 23 comprises in its end a portion of surface plate that comes into contact with the bolt 11 when the aforementioned stop is at end of rotation and the aforementioned bolt is in outer position, the longitudinal axis of the stop 23 being aligned with the longitudinal axis of the bolt 11. This position at end of stroke and this portion of surface plate enable the stop 23 to obtain a stabilized position and enables releasing of the flexible link 15 from the force of the springs 13.

FIG. 26 shows a second variant of the device of FIG. 22, in which, when the stop 23 is at the end of rotation, its longitudinal axis goes past the longitudinal axis of the bolt 11 and the thrust axis of the spring 13 which, exerting its force, compresses the aforementioned stop against the upper wall of the recess 21 of the internal support 9, enabling attainment of a blocking position of the aforementioned stop, and enabling releasing of the flexible link 15 from the force of the springs 13 for a stabilized position of the entire system in extended position of the telescopic support. The press on the trigger 3 releases the force of the spring 25 which pulls downward on the flexible link 15, the flexible link displacing, exerting a downward force on the rotating cams 23 which, by their rotation, press on the bolts 11, compress the springs 13, and go past the longitudinal axis of the bolts which can then laterally displace and return to their inner position in the internal supports 9 under the force of the springs 13.

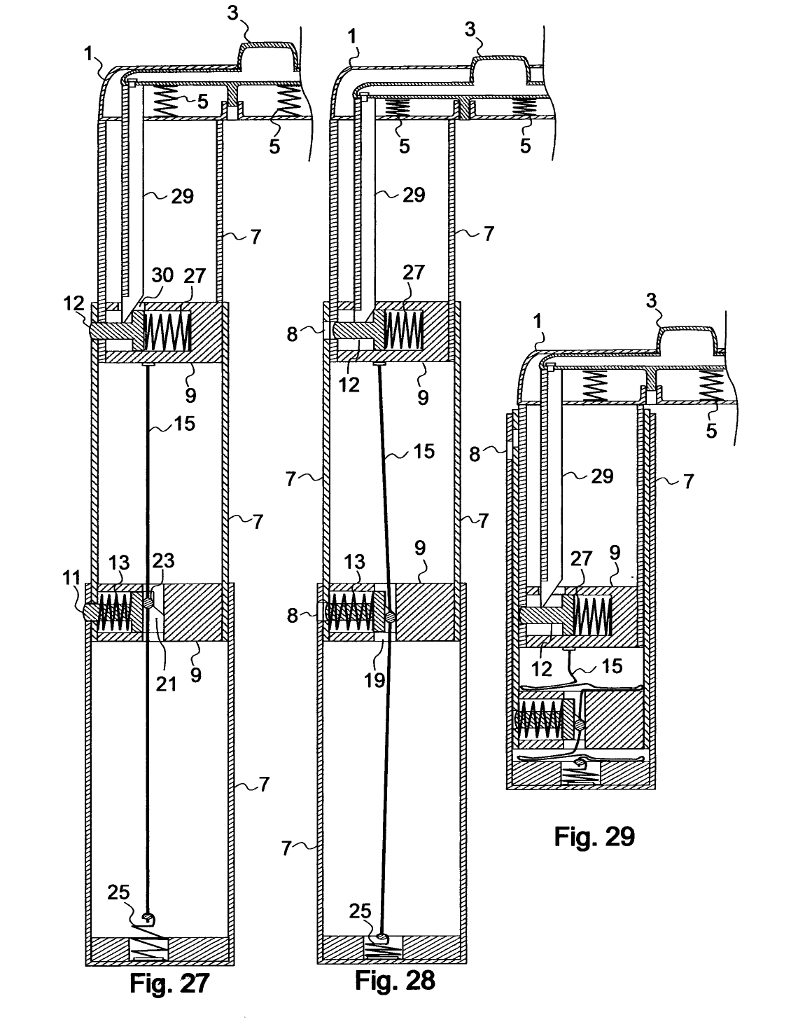

The fourth implementation mode, FIGS. 27, 28 and 29, comprises the same elements as the device of FIG. 10, it differs in that the trigger 3 is connected to a rod 29 and in that the bolt 12 of the upper internal support is equipped with a spring 27 that compresses and holding the aforementioned bolt 12 in outer position, in the orifice 8 of the intermediate segment, locking the upper segment 7 in extended position, FIG. 27. A press on the trigger 3, FIG. 28, compresses the two springs 5 and drives the downward displacement of the rod 29 whose beveled tip is inserted in the orifice 30 of the upper internal support 9. The beveled tip of the rod 29 exerts against the bolt 12, an inverse force greater than the force of the spring 27 and drives the lateral displacement of the bolt 12 into inner position enabling the sliding and the interfitting of the upper segment 7 in the intermediate segment 7 and enables to the flexible link 15, attached between the upper attachment ring 9 and to spring 25, to be downwardly displaced while having its tension partially relaxed. The stop 23 being been disengaged from its stabilized position, the bolt 11, under the force of the spring 13, displaces into inner position at the internal support 9, releasing the intermediate segment which can slide and interfit into the lower segment 7 by the force of the user. In extended position, FIG. 29, the trigger 3 is in raised position and the springs 5 are released. At the deployment of the telescopic support, when the upper segment 7 aligns its orifice 8 opposing the bolt 12 of the internal upper support 9, the aforementioned bolt is displaced into outer position by the spring 27.

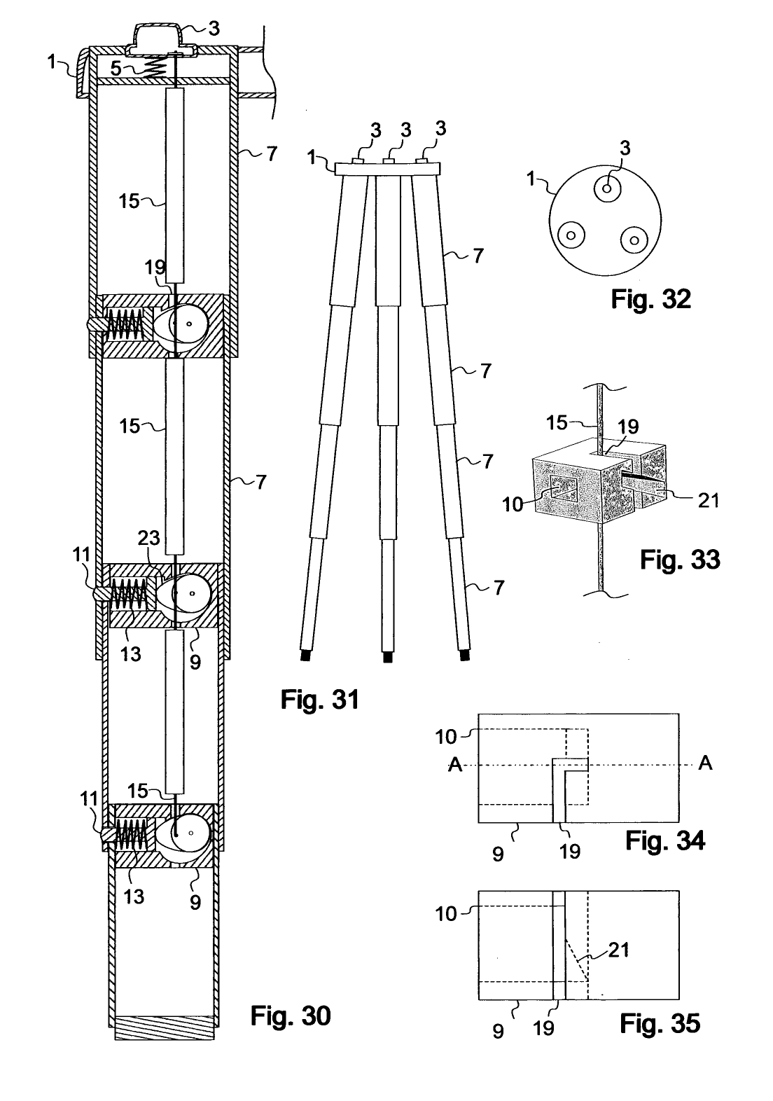

The fifth implementation mode, FIGS. 30, 31 and 32, comprises the same elements as the device of FIG. 22, it differs in that the width of the sliding segments 7 is reversed, the widest element being located at the top, close to the trigger 3 which enables control of the lock mechanism of a single telescopic support constituted by four sliding segments 7 and equipped with three internal supports 9. The flexible link is composed of multiple strap type large portions, enabling an organized folding and limiting the risk of tangling. The trigger 3 is attached to the broadest upper segment 7. FIG. 30 shows one of the telescopic supports of the device of FIG. 31. In FIGS. 31 and 32, three telescopic supports according to the device of FIG. 30 are connected at their top by a handle 1.

In FIG. 33, the attachment ring 9 comprises a recess 10 enabling the displacement of a bolt, an inclined recess 21 enabling the displacement of a stop and an orifice 19 traversed by the flexible link 15.

In FIG. 34, the internal support 9 comprises an orifice enabling the flexible connection to travel and a recess 10 enabling the bolt to travel.

In FIG. 35, the internal support 9 includes an opening 19 enabling the flexible connection to travel and a recess 10—shown in dashed lines—enabling the bolt to travel. The sloped recess 21 enabling the stop to travel is formed in the extension of the recess 10.

In the claims, the word “comprising” does not exclude other elements and the indefinite article “a/an” does not exclude a plurality.

The device according to the invention is particularly designed for telescopic supports for apparatus for shooting, photo, video, telescopic handles and telescopic supports of telescopic storage devices.

1. A telescopic support device with simultaneous unlocking characterized in that it comprises:
a trigger with spring, positioned on the upper part of the telescopic support, controlling the tensioning and the release of a flexible link connected by its upper end to the aforementioned trigger and by its lower end to the base of the lowermost sliding segment,
multiple sliding segments fitting into each other, each sliding segment comprising an attachment ring, each attachment ring comprising a recess through which travels a bolt equipped with a spring whose force compresses the aforementioned bolt into position into the interior of the attachment ring, the aforementioned attachment ring comprising an orifice wherein the flexible link travels along each bolt,
such as the aforementioned device is movable between three positions:
an extended position, obtained by the deployment of segments in maximum position, wherein the bolts are engaged in the orifices of the sliding segments by tensioning and displacement of the flexible link, such that the aforementioned segments are blocked in their sliding,
an intermediate position, obtained in the maximum deployment position of the sliding segments, by pressing the trigger that displaces and slackens the flexible link, such that each spring compresses each bolt to the interior of each attachment ring, enabling the interfitting of the aforementioned segments on top of each other.
a folded position, obtained by folding of the segments, wherein the flexible link is slackened and each spring compresses each bolt to the interior of each attachment ring.

2. A device according to claim 1, characterized in that each attachment ring comprises a recess wherein a stop travels, each stop being connected to the flexible link, such that, in the extended position, each stop is displaced in each recess by the tensioning of the flexible link, driving the displacement of each bolt into the outer position in the orifices of the segments.

3. A device according to claim 2, characterized in that the orifice is positioned such that the tensioning of the flexible link displaces each stop in its recess driving each bolt into the outer position in the orifices of the segments.

4. A device according to claim 3, characterized in that the recess of the attachment ring, wherein the stop travels, is inclined and each stop is attached to the flexible link, such that the tensioning and the upward displacement of the flexible link drives each stop in a stroke both vertical and horizontal displacing each bolt into outer position in the orifices of the segments.

5. A device according to claim 4, characterized in that the flexible link is connected, at its lower end, to a spring less powerful than the spring (5), such that in maximum extended position of the segments, a press on the trigger enables the aforementioned spring to drive the downward displacement of the flexible link as well as a partial relaxation of its tension.

6. A device according to claim 5, characterized in that the inclined recess comprises a vertical portion, positioned such that the stop at end of stroke engages between the aforementioned vertical portion and the bolt, enabling the blockage of the aforementioned bolt in external position and releasing the flexible link from the force exerted by the spring.

7. A device according to claim 4, characterized in that the recess is entirely vertical and the surface of the bolt in contact with the stop comprises an inclination in its lower part, such that the tensioning of the flexible link and the elevation of the stop generates the displacement of the aforementioned bolt into outer position, and characterized in that the surface of the bolt in contact with the stop comprises a vertical portion in its upper part, such that the stop at end of stroke engages between the vertical portion of the aforementioned bolt and the vertical wall of the aforementioned recess, blocking the aforementioned bolt in outer position and releasing the flexible link from the force of the spring.

8. A device according to claim 2, characterized in that each stop has a rotary cam shape, such that rotation of each stop, generated by the displacement and the tensioning of the flexible link, drives the displacement of each bolt into outer position.

9. A device according to claim 8, characterized in that the surface of the stop in contact with the bolt comprises a flat portion at its end, such that when the aforementioned stop is positioned at the end of stroke and the bolt is in outer position, the longitudinal axis of the stop is aligned with the longitudinal axis of the bolt and the force of the spring on the aforementioned bolt blocks the aforementioned stop position in stabilized position, releasing the flexible link from the force of the spring.

10. A device according to claim 8, characterized in that the longitudinal axis of the stop positioned at the end of rotation goes past the longitudinal axis of the bolt in outer position, such that the force of the spring on the aforementioned bolt blocks the aforementioned stop in stabilized position against the wall of the recess, releasing the flexible link from the force of the spring.
